(19) United States
(12) Patent Application Publication
(10) Pub. No.: US 2016/0070754 A1
(43) Pub. Date: Mar. 10, 2016

(54) SYSTEM AND METHOD FOR MICROBLOGS DATA MANAGEMENT

(71) Applicants: UMM AL-QURA UNIVERSITY, Makkah (SA); KING ABDULAZIZ CITY FOR SCIENCE AND TECHNOLOGY, Riyadh (SA)

(72) Inventors: Mohamed Fathalla Hassan MOKBEL, Makkah (SA); Amr Magdy Mahmoud AHMED, Makkah (SA)

(73) Assignees: UMM AL-QURA UNIVERSITY, Makkah (SA); KING ABDULAZIZ CITY FOR SCIENCE AND TECHNOLOGY, Riyadh (SA)

(21) Appl. No.: 14/841,299

(22) Filed: Aug. 31, 2015

Related U.S. Application Data
(60) Provisional application No. 62/048,728, filed on Sep. 10, 2014.

(51) Int. Cl. G06F 17/30

(52) U.S. Cl. CPC G06F 17/30463; G06F 17/30448; G06F 17/3033

(57) ABSTRACT

A microblogs data management system and method that includes receiving, via communication circuitry, microblogs from a plurality of sources, storing, in a memory, the microblogs wherein the memory is temporally partitioned, transferring, using processing circuitry, a batch of the microblogs to an intermediate disk buffer when the memory is full, wherein the batch of the microblogs is selected based on a query and a temporal flushing policy, and transferring microblogs stored in the intermediate disk buffer to disk indexes.

### CROSS-REFERENCE TO RELATED APPLICATIONS

This application claims the benefit of priority from U.S. Provisional Application No. 62/048,728 filed Sep. 10, 2014, the entire contents of which are incorporated herein by reference.

### BACKGROUND

Online social media services have gained considerable popularity in the last decade which has led to explosive growth in size of microblogs data. The microblogs data include data from tweets, Facebook comments and foursquare check-ins. As user-generated data, microblogs form a stream of rich data that carries different types of information including text, location information, and users' information. Moreover, microblogs textual content is rich with user updates on real-time events, interesting keywords and hashtags, new items, opinions and reviews, hyperlinks, images, and videos. Existing data stream management systems are not equipped to handle the newly emerging real-time queries and applications on microblogs. What is needed, as recognized by the present inventor, is a system that supports querying, analyzing, and visualizing of microblogs.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

The present disclosure relates to a microblogs data management system and associated methodology that receives via communication circuitry, microblogs from a plurality of sources. stores, in a memory, the microblogs wherein the memory is temporally partitioned, transfers, using processing circuitry, a batch of the microblogs to an intermediate disk buffer when the memory is full, wherein the batch of the microblogs is selected based on a query and a temporal flushing policy, and transfers, using the processing circuitry, microblogs stored in the intermediate disk buffer to disk indexes.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an exemplary schematic of a system for microblog data management according to one example;

FIG. 2 is a block diagram representation of a system for microblog data management according to one example;

FIG. 3 is a schematic of the microblogs data management system in memory indexes according to one example;

FIG. 4 is a schematic representation of the microblog management system disk spatial index according to one example;

FIG. 5 is a flow chart for query plan selection according to one example;

FIG. 6 is a flow chart for the generation of a query plan according to one example;

FIG. 7 is a flow chart for microblogs management system according to one example;

FIG. 8 is an exemplary user interface provided by the system according to one example;

FIG. 9 is an exemplary user interface provided by the system according to one example;

FIG. 10 is an exemplary block diagram of a server according to one example;

FIG. 11 is an exemplary block diagram of a data processing system according to one example; and

FIG. 12 is an exemplary block diagram of a central processing unit according to one example.

### DETAILED DESCRIPTION

Referring now to the drawings, wherein like reference numerals designate identical or corresponding parts throughout several views, the following description relates to a microblog management system and associated methodology for managing, querying, analyzing, and visualization of microblogs.

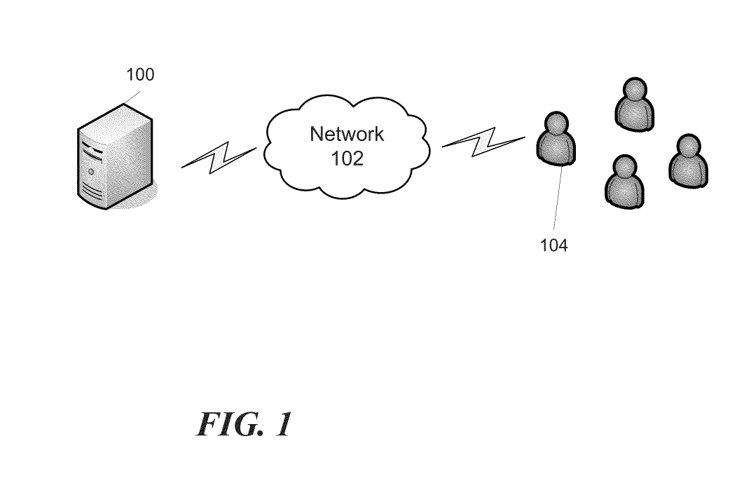

FIG. 1 is an exemplary schematic of a system for microblog data management according to one example. A user 104 sends data to a server 100 via a network 102. The data may represent microblogs data generated from social media services such as tweets, Facebook comments, and Foursquare check-ins. The user 104 may represent a plurality of users. The user 104 may generate the microblogs data using a mobile device. The mobile device may be further equipped with a location detector in order to generate geotagged microblogs data. For example, Global Positioning System (GPS) circuitry may be included in the mobile device as would be understood by one of ordinary skill in the art. In one embodiment, the mobile device location may be determined via a cellular tower with which communication has been established using current technologies such as Global System for Mobile (GSM) localization, triangulation, Bluetooth, hotspots, WIFI detection, or other methods as would be understood to one of ordinary skill in the art. In one embodiment, the mobile device location is determined by the network 102. In particular, it may detect a location of the mobile device as a network address on the network 102. The mobile device location corresponds to the user location. Once the mobile device location is determined by any of the techniques described above or other methods as known in the art, the user location is likely known. The user location is then associated with the microblogs data sent by the user 104. The user 104 may also indicate the location using the mobile device. The server 100 manages the microblogs data. Further, the user 104 may send one or more query to the server 100 via the network 102. The server 100 may process the query and send the answer to the mobile device of the user 104 via the network 102. The mobile device may be a smartphone, a computer, a tablet or the like.

The network 102 is any network that allows the user 104 and the server to communicate information with each other such as a Wide Area Network, Local Area Network, or the internet. The server 100 may include a CPU 1000 and a memory 1002. The server 100 may represent one or more servers connected via the network 102.

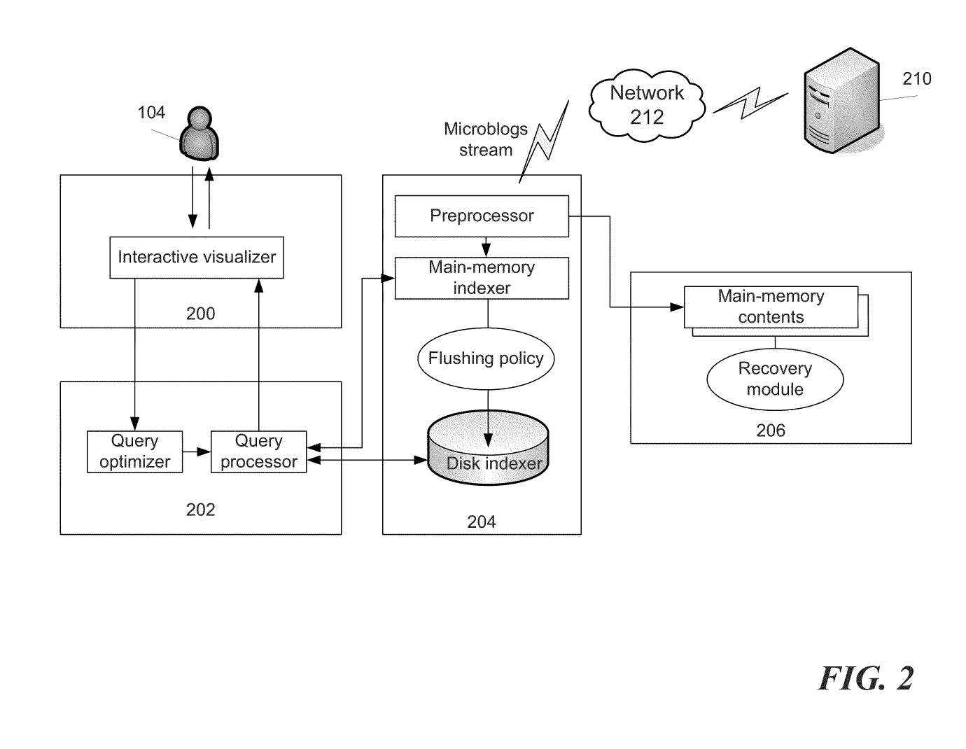

FIG. 2 is a block diagram representation of a system for microblog data management according to one example. In one embodiment, the microblog data management system may include four main components. The microblog data management may include an indexer 204, a query engine 202, a recovery manager 206, and a visualizer 200. The indexer 204 is responsible for handling the microblogs data. The indexer 204 may include a preprocessor. The preprocessor receives real time microblogs and perform location and keyword extraction. The CPU 1000 may analyze the microblogs using statistical algorithms and natural language processing technology, as would be understood by one of ordinary skill in the art, to extract keywords. The keywords can be used to index content. The CPU 1000 may also analyze the microblogs using technique such as Named Entity Recognition (NER) to extract location data. Location data may include geographic location such as country, city, river or the like and point of interest (POI) such as hotels, shopping centers, restaurants, or the like. The real time microblogs are then continuously processed in a main-memory indexer. The CPU 1000 may check whether the main-memory is full. In response to determining that the main-memory is full, a subset of the microblogs stored in the main-memory are selected, using a flushing module, to be consolidated into scalable disk indexers that are able to manage a large number of microblogs for long periods. The long periods may be up to several months. The indexer 204 is further explained below. Each of the modules and components described herein may be implemented in circuitry that is programmable (e.g. microprocessor-based circuits) or dedicated circuits such as application specific integrated circuits (ASICS) or field programmable gate arrays (FPGAS).

The query engine 202 may consist of two main sub-components: a query optimizer and a query processor. The query optimizer takes the query of the user 104 from the visualizer 200 and generates an optimized query plan to hit the system indexes efficiently. The query optimizer provides the optimized query plan to the query processor. The query processor takes the query plan, executes it using the CPU 1000, and provides a query answer to the visualizer 200. The query engine 202 is further explained below.

The recovery manager 206 may employ a predetermined number of redundancy model for backing contents of the main-memory. For example, the predetermined number may be three. In response to determining that the memory has failed, the backup copies are used to restore the system. The recovery manager 206 is explained further below.

The visualizer 200 is an interactive component to interact with the user 104. The visualizer 200 allows the user 104 to issue queries. After receiving the query from the user 104, the visualizer dispatches the query to the query engine 202. The visualizer 200 then receives the answers from the query engine 202, and displays the answers to the user 104. The visualizer 200 may present the answers in a graphical form.

The system and associated methodology of the present disclosure may support any query on microblogs that involves spatial, temporal, and keywords attributes. In one embodiment, the query may have a temporal dimension and a spatial and/or keywords dimension. The queries are answered by filtering, using the CPU 1000, a search space through hitting the system indexes for the spatial, temporal, and keywords attributes. The CPU 1000 may check whether the query includes additional attributes. In response to determining that the query includes additional attributes, the system may use a generic distributed data scanner that may refine the answer based on the additional attributes as would be understood by one of ordinary skills in the art.

Keeping the most recent data in the main-memory may speed up the query responses as most of the real-world queries access the most recent data. Due to the high number of microblogs, not all the microblogs may be stored in the main-memory. Thus, the system indexing includes both main-memory and disk-resident indexes. The microblogs data management system described herein employs efficient index update techniques, as described below, to be able to digest high arrival rates of microblogs.

The microblog data management system can communicate with a remote computer 210 via a network 212 to obtain the microblog data. In an embodiment, the microblog data management system can use an application program interface provided by a microblog service provider to obtain microblog data from a microblog service provider's database. For example, the microblog data management system can use Twitter Streaming Application Program Interfaces (APIs) provided by Twitter, Inc. company to receive a Twitter microblog data stream from a remote server. Specifically, the microblog data management system can use a local client application to send a request to the remote server to set up a HTTP connection. The remote server can then retrieve microblog data from a database inside a network of Twitter company and transmit the Twitter microblog data to the microblog data management system. In an example, the Twitter microblog data is transmitted in real time while the Twitter users are posting microblogs using Twitter service. In an alternative embodiment, the microblog data management system can access a microblog service provider's database using account information of one or more users who register for the microblog service provider's service to obtain the microblog data posted by the users.

The network 212 can be a wide area network, such as the Internet, a third generation (3G) wireless mobile network, a fourth generation (4G) wireless network, or the like.

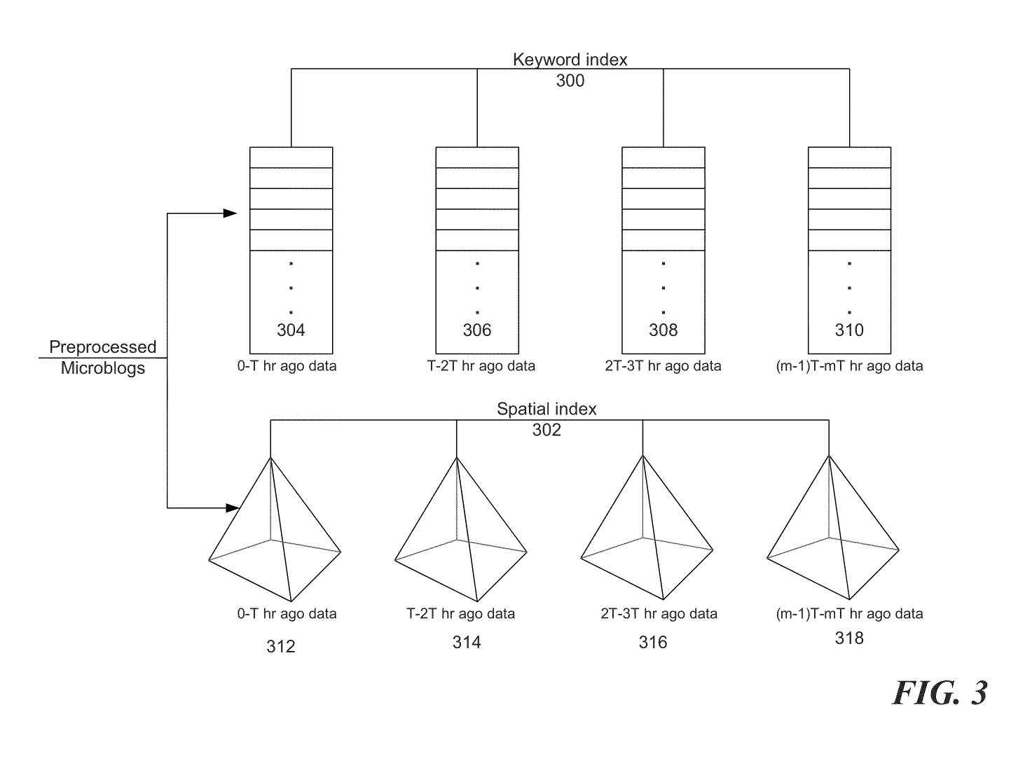

FIG. 3 is a schematic of the microblogs data management system in-memory indexes according to one example. FIG. 3 shows the organization of the in-memory indexes. The indexer 204 may employ two segmented indexes in the main-memory: a keyword index 300 and a spatial index 302. The keyword index 300 and the spatial index 302 are temporally partitioned into one or more successive disjoint index segments. Each segment indexes the data of a predetermined number of hours “T”. As shown in FIG. 3, the keyword index may be divided into “m” segments. A first segment 304 may hold data from zero hours to the predetermined number of hours. A second segment 306 may hold data from the predetermined number of hours until twice the predetermined number of hours. A third segment 308 may hold data from 2T to 3T. An m^{th} segment 310 may hold data from (m−1)T to mT. The predetermined number of hours may be optimized by the flushing module of the indexer 204. The newly incoming microblogs are digested in the first segment 304.

Once the segment spans the predetermined number of hours of data, the segment is concluded and a new empty segment is created, by the CPU 1000, to digest the new data. Index segmentation provides many advantages. The newly incoming microblogs are digested in a smaller index, which is the most recent segment, and hence becomes more efficient. In addition, the index segmentation may facilitate the transferring (flushing) of data from the main-memory to disk using a plurality of flushing techniques.

The keyword index segment is an inverted index that organizes the data in a hash table. The hash table maps a single keyword (the key) to a list of microblogs that contains the keyword. The list of microblogs of each keyword is reverse-chronologically ordered so that the insertion is always in the list front item as would be understood by one of ordinary skill in the art. With such optimization, the microblogs data management system is able to digest up to 32,000 microblog/second.

The spatial index segment may use a pyramid index structure that employs efficient updating and structuring techniques to provide a light-weight spatial indexing. Each pyramid segment may hold data for the predetermined number of hours. FIG. 3 shows a first pyramid segment 312, a second pyramid segment 314, a third pyramid segment 316, and a m^{th} pyramid segment 318. The pyramid index is a space-partitioning tree of cells, where each cell has either zero or four children cells, and sibling cells cover equal spatial areas. Unlike data-partitioning indexes such as R-tree, the pyramid index may support high digestion rates due to the low restructuring overhead with newly incoming data. Each cell has a capacity of certain number of microblogs, where the capacity is a system parameter. The microblogs inside each cell may be stored in a reversed chronological order.

When the microblogs are received, the CPU 1000 may check whether a first cell has enough capacity. In response to determining that the microblogs exceeds the capacity of the first cell, the first cell is split into four children cells. In one embodiment, the first cell is split when the microblogs lie in at least two different quarters of the cell.

In one embodiment, underutilized cells are not merged immediately. This eliminates redundant merge operations. Instead, four siblings are merged, in lazy basis, only when three of them are completely empty. Such lazy split and merge operations saves 90% of the structuring operations in the highly dynamic microblogs environment. In addition, the index structure stabilizes relatively fast which decreases the structuring overhead to its minimal levels. To update the index efficiently, the microblogs are inserted in batches, periodically each predetermined number of seconds 1. This avoids traversing the pyramid levels for each individual microblog. In one embodiment, the predetermined number of seconds may be between 1 to 2 seconds so that several thousands of microblogs are inserted in each batch. Then, the pyramid levels are traversed once with minimum bounding rectangle of all the microblogs in the batch. This saves thousands of comparison operation in each insertion cycle thus minimizing computation.

In one embodiment, the system and associated methodology of the present disclosure may use disk indexes to manage the microblogs that are expelled from the main-memory by the flushing module. All the deletion operation from the in-memory indexes are handled by the flushing module.

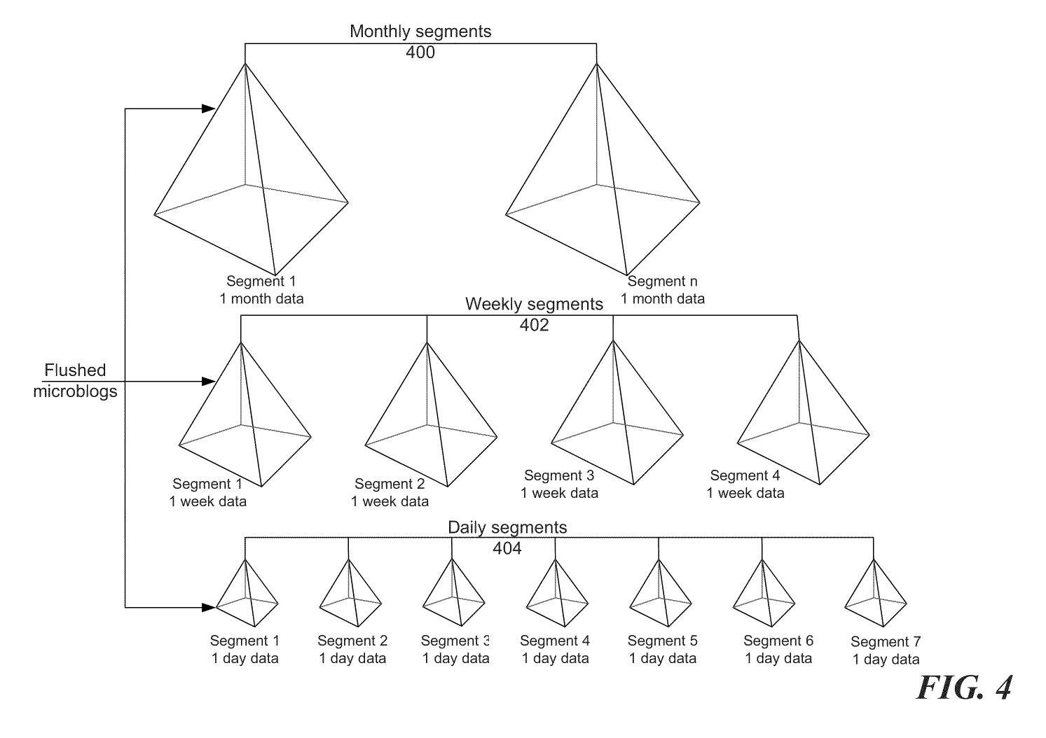

FIG. 4 is a schematic representation of the microblog management system disk spatial index according to one example. The system employs two disk indexes: a keyword index and a spatial index. The keyword index may have a similar organization as the spatial index. The keyword index and the spatial index are organized in temporally partitioned segments. The temporally partitioned segments may be replicated in a hierarchy of three levels, daily segments 404, weekly segments 402, and monthly segments 400. The daily segments 404 stores the data of each calendar day in a separate segment. The weekly segments 402 may consolidate the data in each successive seven daily segments that forms data for one calendar week in a single weekly segment. The monthly segments 400 may consolidate data of each successive four weekly segments in a single segment that manages the data of a whole calendar month. The main reason behind replicating the indexed data on three temporal levels is to minimize the number of accessed index segments while processing queries for different temporal periods. For example, for an incoming query asking about data of two months, if only daily segments are stored, then the query processor needs to access sixty indexes to answer the query. On the contrary, to the described setting, the query processor needs to access only two indexes of the two months' time horizon of the query. This significantly reduces the query processing time so that the microblogs management system is able to support queries on relatively long periods. In one embodiment, a different number of temporal levels may be used.

In one embodiment, the disk keyword index segments may be inverted indexes. The spatial index segments may be R+-trees. Unlike a pyramid structure, R+-tree is disk-friendly where tree nodes are disk pages. At any point of time, only a single daily segment is active to absorb the expelled microblogs from the main-memory. Once a one full day passes, the current active daily segment is concluded and a new empty segment is introduced to absorb the next incoming data. Upon concluding seven successive daily segments, the CPU 1000 creates a weekly segment. Then the CPU 1000 may merge the data of the whole week in the weekly segment. The CPU 1000 may also conclude the weekly segment, once a week has passed. The CPU 1000 may determine that the week has passed by using an internal clock. In response to determining that four weekly segments have been concluded, the CPU 1000 creates a monthly segment. The weekly segments are then merged into the monthly segment. In one embodiment, different, other segment categories may be created. For example, a bi-weekly segment may be created. In one embodiment, the segment may hold data for any predetermined number of hours or days. In one embodiment, the CPU 1000 may update a count in the memory. When the CPU 1000 creates a segment, a count/number is increased by a predetermined incremental value. In one embodiment, the CPU 1000 may maintain a daily count and a weekly count. For example, when the CPU 1000 creates a new weekly segment, a weekly count may be increased by one. The CPU 1000 may then determine whether to create a new monthly segment by comparing the weekly count with a predetermined value. The predetermined value may be equal to four.

Disk indexes are temporally disjoint from the main-memory indexes. In other words, whenever the microblogs management system inserts data in the disk indexes, there exists a check point timestamp t_{cp} where all the data in the main-memory indexes are more recent than t_{cp} and all the data in disk-based indexes are older than or equals to t_{cp}. This guarantees that consolidating data from main-memory keyword index into disk keyword index is done very efficiently through bucket-to-bucket mapping without bothering with deforming the temporal organization of the data.

The following method may be used to consolidate data from main-memory keyword index to disk keyword index. The CPU 1000 may determine whether the new data requires the creation of a daily segment. The determining may be done by checking the oldest and the newest timestamps of the data to be flushed. The timestamp are obtained from the flushing manager module. When the two timestamps span two different days, then a new daily segment is created by the CPU 1000.

The CPU 1000 maps each slot from the main-memory to the corresponding slot in the active disk index segment, based on the keyword hash value. Each slot contains a list of microblogs that are stored in a reverse chronological order.

Then, the CPU 1000 merges the data list L of the main-memory, into the existing microblogs list on the disk. The CPU 1000 may check whether data L spans two days. In response to determining that the data L spans two days, the list may be divided into two sub-lists. Two index segments may be accessed. Next, the CPU 1000 merges the list/sub-list into the corresponding slot by prepending the list to the existing disk list. This is O(1) operation due to the temporal order and disjointness of the two lists as would be understood by one of ordinary skill in the art.

The CPU 1000 may consolidate data from the pyramid index of the main-memory to the R+-tree index of the disk by flushing data in raw format, where batches of microblogs are bulk loaded to the R+-tree without any mapping between the memory index partitions and disk index partitions. As R+-tree is disk-friendly, the bulk loading flushing is efficient enough to handle the segmented microblogs data.

The main task of the flushing manager module is to determine which microblogs should be flushed from the main-memory indexes to disk indexes, when the main-memory becomes full. The incoming queries to the server 100 via the network 102 are answered from both the main-memory and the disk contents.

The more relevant data in main-memory, the less disk access is needed to answer the queries, and then a lower query response time is possible. Thus, the flushing module may employ a plurality of flushing policies. The flushing policy tries to compromise the indexing and flushing overhead with the availability of relevant data, to incoming queries, in the main-memory.

In one embodiment, the system may use a Flush-All technique. The Flush-All technique dumps the contents of the memory to the disk. This makes the main-memory indexing very flexible as any number of segments can be used without dramatic effect on the flushing process. Also, it minimizes the disk access overhead as less number of flushing operations are performed. The Flush-All technique preserves the property of temporal disjointness between main-memory contents and disk-contents as it dumps all the old data to the disk before receiving new data in the main-memory.

In one embodiment, the system may use a Flush-Temporal technique. The Flush-temporal technique expels a certain portion of the oldest microblogs to empty room for the newly real-time incoming microblogs. To reduce the flushing overhead, the Flush-temporal technique requires the main-memory indexing to partition the data into segments with the same flushing unit. Referring to the main-memory index organization shown in FIG. 3, the flushing unit is defined as T hours, i.e., the oldest T hours of data are flushed periodically. In the Flush-Temporal technique, T may be a system parameter that is adjusted by a system administrator based on the available memory resources, the rate of incoming microblogs, and the desired frequency of flushing. In one embodiment, the system parameter may be determined by the CPU 1000. Flush-Temporal also preserves the property of temporal disjointness between main-memory contents and disk-contents as it dumps data of a certain period of time. This moves the temporal check point t_{cp} by exactly T hours without causing any kind of temporal overlap. In addition, Flush-Temporal has the advantage of not causing sudden significant system slowdowns.

In one embodiment, the system may use a Flush-Query-Based technique. The Flush-Query-Based technique may expel the microblogs that are not relevant to the incoming queries. This is important when it is required to optimize the system indexes to support certain query or a set of queries efficiently. The CPU 1000 may determine the characteristic of data that may not satisfy the target query answer, and hence expel them. For example, when the query asks for most recent k microblogs that contain a certain keyword, the CPU 1000 may check whether the inverted index slot of any keyword contains more than k microblogs. In response to determining that the inverted index slot of any keyword contains more than k microblogs, those microblogs can be expelled to empty a space for more relevant microblogs to reside in the main-memory. Microblogs older than the kth are not needed for the query answer.

In one embodiment, the system and associated methodology of the present disclosure flush data to an intermediate disk buffer rather than flushing directly to the disk indexes. The CPU 1000 may use a query-based flushing policy combined with a temporal flushing policy (with larger values of T) so that after a certain point in time it is guaranteed that all main-memory data are more recent than a certain timestamp. Then, all the data in the intermediate buffer may be merged to the disk indexes without violating the temporal disjointness. The method of the present disclosure has the advantage to reduce disk access overhead during query processing.

The flushing operations do not affect the data availability. The main-memory data stay available to the incoming queries until the flushing operation is successfully completed. Then, the temporal checkpoint, t_{cp}, is updated to indicate the new temporal boundaries between the main-memory contents and the disk contents. If concurrent queries have already read the old t_{cp} value, the system keeps track of them using a pin counting technique as would be understood by one of ordinary skills in the art, before the flushing manager module discards the flushed main-memory contents.

As explained above the system provides two types of indexes in both main-memory and disk: keyword index and spatial index. In addition, disk indexes data may be replicated on three temporal levels, daily, weekly, and monthly index segments. Consequently, the query processor may have different ways to process the same query based on: (1) the order of performing keyword or spatial filtering based on the system indexes, and (2) the number of hit disk indexes. For example, the query that asks about only spatial data of the period from June 1 to June 9 can be answered from disk spatial indexes in two different ways: (a) either accessing nine daily index segments, or (b) accessing one weekly and two daily index segments. Each of those is called a query plan. The costs of different query plans may be different. The main task of the query optimizer is to generate a plan to execute so that the estimated cost is minimal.

When a query involves querying both spatial and keyword dimensions, the CPU 1000 may retrieve the microblogs using two methods. In a first method, the CPU 1000 may hit the keyword index and perform spatial filtering for the retrieved microblogs. In the second method, the CPU 1000 may hit the spatial index and then perform keyword for the retrieved microblogs.

To select one of the two methods, the query optimizer employs a cost model. The CPU 1000 calculates the estimated cost for each plan and selects the lowest one.

For a query q, the costs of both methods are calculated based on the following equations:

Cost(keyword|_{q})=A_{kw}×query_keyword_count (1)

Cost(spatial|_{q})=Aₛₚ×query_area (2)

Equation (1) is used to estimate the cost of hitting the keyword index given q while Equation (2) is used to estimate the cost of hitting the spatial index given q. The cost of q depends on its number of keywords and its spatial extent. The system calculates a single value for each index, namely, A_{kw} and Aₛₚ. A_{kw} is the average number of microblogs in a keyword slot. Aₛₚ is the average number of processed microblogs per query area of one mile square. The query optimizer, using the CPU 1000, is able to estimate the number of microblogs that need to be processed to provide the query answer based on A_{kw} and Aₛₚ. In the main-memory, this estimates the amount of processing needed. On disk, this estimates the number of pages that needs to be retrieved from disk.

To calculate A_{kw}, two values are stored in the memory 1002 for each keyword index: the total number of microblogs inserted so far in an index Total_{M}, and the number of distinct keywords inserted in the index N_{kw}. The CPU 1000 may calculate A_{kw} using:

$${A}_{kw} = \frac{{Total}_{M}}{{N}_{kw}} \qquad ( 3 )$$

Both Total_{M} and N_{kw} are easy to store and update during the index update operations with almost no overhead. To calculate Aₛₚ, two values are stored in the memory 1002 for each spatial index: the summation of average numbers of microblogs processed under each incoming query since the index is created Sum_{avg}, and the number of queries processed on the index Nq. Aₛₚ can be then expressed as:

$${A}_{sp} = \frac{{Sum}_{avg}}{{N}_{q}} \qquad ( 4 )$$

To update and store Sum_{avg}, for each query, the CPU 1000 may keep track of the total number of processed microblogs during the query. For example, the CPU 1000 may store a count of the number of processed microblogs. When a microblog is processed, the count of the number of processed microblogs is updated. Then, the count may be reset when the query is answered. Then, this number may be divided by the query area (in miles square). Finally, the CPU 1000 may add the division result to Sum_{avg} while Nq is increased by an incremental value. It is worth noting that A_{kw} is changing over time with the data keyword distribution, while Aₛₚ is changing over time with the query load spatial distribution. This dynamic learning process of A_{kw} and Aₛₚ continuously improves the cost estimation and hence the query performance.

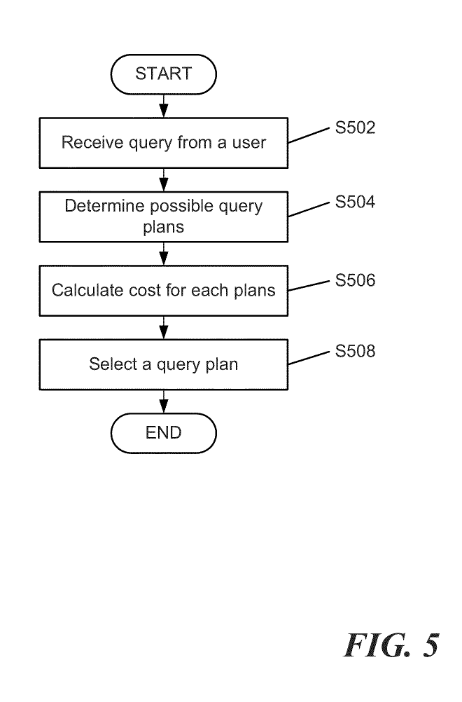

FIG. 5 is a flow chart for a query plan selection according to one example. At step S502, the system receives the query from the user. At step S504, the CPU 1000 determines possible query plan. At step S506, the CPU 1000 may calculate a cost for each query plan determined at step S504. In one embodiment, the CPU 1000 may use equations (1) and (2) to calculate the cost. At step S508, the CPU 1000 may compare the costs for each query plan to determine the lowest cost.

As data on disk is replicated on three levels of temporal hierarchy, there are usually different ways to access data in certain temporal range: from a daily index, a weekly index, or a monthly index. To estimate the cost of hitting each index individually, equations (1) and (2) may be used. However, there are different valid combinations of indexes. The query optimizer starts with the combination with the minimum amount of data to be accessed to minimize the overhead of getting an optimal combination of indexes. This means using weekly and monthly indexes only for whole weeks and whole months, respectively, in the query temporal horizon. For example, if the query temporal horizon spans May 29 to July 9, then the starting combination is three daily indexes for last three days of May, one monthly index for whole June, one weekly index for first week of July, and two daily indexes for July 8 and 9. These indexes do not contain any data outside the query temporal boundary thus containing the minimum amount of data to be accessed. Going up in the index temporal hierarchy may increase the cost. In the example described herein, replacing the three daily indexes of the last three days of May with one weekly index of the last week of May incurs more cost as more disk pages are retrieved. Thus, the employed heuristic is to go down in the index hierarchy to explore and to divide weekly and monthly indexes into finer granularity indexes, i.e., days and weeks, respectively. Starting from the first generated combination, the query optimizer tries to replace weekly indexes with seven daily indexes (and monthly indexes with four weekly indexes). Checking the costs of these combinations is not costly as it is just summation of seven (four) cost parameters numbers, i.e., A_{kw} and Aₛₚ. The optimizer module using processing circuitry then selects the combination with the minimum estimated cost.

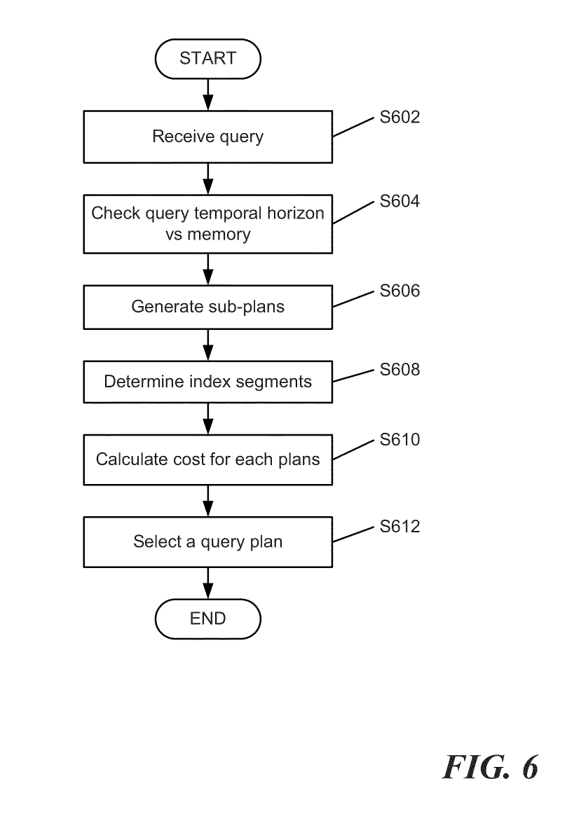

FIG. 6 is a flow chart for the generation of a query plan according to one example. At step S602, the system receives a query. At step S604, the optimizer checks the query temporal horizon versus the memory/disk data temporal boundary, t_{cp}, to determine the temporal horizon of both memory and disk data, namely, tₘ and t_{d}, respectively. At step S606, a sub-plan is generated for each of them separately. At step S608, in the main-memory, the index segments that intersect with tₘ are determined. At step S610, the index to be hit (either keyword or spatial) is selected based on the above selection model shown in FIG. 5. On disk, an index combination is generated for both spatial and keyword index hierarchies. Then, the cost of each combination is estimated based on equations (1) and (2) where the cheapest one is selected at step S612.

To provide flexible and efficient spatio-temporal querying framework, the system of the present disclosure employs indexes on spatial, temporal, and keyword attributes and perform filtering on all other attributes through efficient distributed data scanners. Thus, the query processor may have two or more phases for answering any queries. In a first phase, the query processor may retrieve a candidate set of microblogs from a spatio-temporal or a keyword temporal space, depending on the query plan. In a second phase, the query processor may perform further processing through scanning on the candidate set when needed as discussed further below.

In the first phase, the query processor may retrieve a list of candidate microblogs based on the query spatial, temporal, and keyword parameters. This is performed by executing the optimized query plan described above through hitting the system indexes. In one embodiment, the query processor may receive a query plan that consists of an optimized set of indexes to be accessed. Each of the indexes is queried to retrieve a list of microblogs that satisfies the user query parameters. The candidate lists are then fed to the second phase for further refinement. As the indexes provide efficient pruning on the indexed attributes, the first phase prunes a huge amount of data.

The output of the first phase may be lists of microblogs that require further processing. The second phase performs the remaining processing, through extensive distributed data scanning, to provide the final query answer. The type of processing depends on the query type and the query plan. When the spatial index is hit in the first phase, then key word filtering is performed in the second phase using the CPU 1000. When the keyword filtering is done in the first phase, then the spatial index is done in the second phase.

In one embodiment, the system described herein may use a standard Microblogs Query Language (MQL). MQL may use two types of statements. A first type of statement may be creation statements. The creation statements are responsible for creating streams and indexes. Streams may be created based on multiple filters. The system may use a keyword filter, a spatial filter, a user filter, a temporal filter or the like. The user, using the CPU 1000, may create a stream of microblogs that contains a word and are posted in a specified location. For example, the user may create a stream that contains the word “President” and generated in “Minneapolis”. The steam can be either of fixed start point or sliding. For example, “president” stream has a fixed start point: its creation point. An exemplary sliding stream may be a stream that includes microblogs for the last day. Thus, this type of streams continuously kicks out old microblogs. The second type of statement may be querying statements.

Also, the scanning is piggybacked by other operations on any other attributes, e.g., counting microblogs of distinct languages or count frequent keywords, so that the system can support a wide variety of queries on different attributes.

With hours and even days of data managed in main-memory, the system of the present disclosure accounts for any failures that may lead to data loss. In one embodiment, the system employs a simple, yet effective, triple-redundancy model where the main-memory data is replicated three times over different machines. Other redundancy model may be employed as would be understood by one of ordinary skill in the art.

The core of the triple-redundancy model is similar to Hadoop redundancy model that replicates the data three times. When the system is launched, all the main-memory modules, e.g., indexes and all data structures, are initiated on three different machines. Each machine is fed with exactly the same stream of microblogs, thus they form triple identical copies of the main-memory system status. One of the three machines is a master machine that launches all the system components, i.e., memory-resident and disk-resident components. The other two machines launch only the memory-resident components. Any flushing from memory to disk in the master machine leads to throwing the data out from the memory of the other two machines. On failure of the master machine, the other two machines continue to digest the real-time microblogs. Once the master machine is recovered, the system memory image is copied to its main-memory from one of the other machines. On the failure of one of the secondary machines, the other machine data is used to create an alternative for the failed machine. Replicating the data three times significantly reduces the probability of having the three machines down simultaneously and losing all the main-memory data.

The recovery management is efficient and scalable. Recovery management through main-memory replication allows these applications to scale without being limited with the overhead of disk-based recovery interactions. In addition, it has the advantage to have a low cost.

The system described herein provides end-to-end solution for microblogs users. The system provides an interactive visualizer component that interacts with end users. The interactive visualizer component handles a rich set of interactive queries with friendly user interfaces.

The interactive visualizer 200 is the system front end. It receives user queries through interactive web-based user interfaces. The queries are then dispatched to the query engine 202 through Java-based function application programming interfaces (APIs) that allow fast interaction, eliminating the overhead of exchanging data in standard formats such as JavaScript Object Notation (JSON), Extensible Markup Language (XML), or the like. The query processor then sends back the answers of the queries so that the visualizer 200 presents them to the user 104.

The system described herein is designed to provide a flexible framework that is able to answer a wide variety of spatio-temporal queries on different microblogs attributes.

Exemplary queries supported by the system are described next. The system may support keyword search queries. Within given spatial and temporal ranges, the system finds all microblogs that contain certain keywords. The system may support Top-k frequent keywords. Within given spatial and temporal ranges, the system may find the most frequent k keywords, for a given integer k. A third exemplary query is to find the top-k active users. Within given spatial and temporal ranges, the system finds the most k active users, for a given integer k. Active users are defined as the users who have posted the largest number of microblogs in the query spatio-temporal range. A fourth exemplary query supported by the system is to find the top k famous users. Within given spatial and temporal ranges, the system finds the most k famous users, for a given integer k. Famous users are defined as the users having the largest number of followers. The query answer is selected from users whose home locations lie in the query spatial range and have posted at least one microblog during the query temporal range.

A fifth exemplary query supported by the system is daily aggregates. Within given spatial and temporal ranges, the system finds the number of microblogs in each day. A sixth exemplary type of query is Joint collective queries. Within given spatial and temporal ranges, the system finds the answer for all the previous queries collectively. An example of collective queries is when multiple queries share the processing power. This significantly reduces the amount of processing consumed per microblog. Another exemplary query is to find the most k used languages within a given spatial and temporal range.

There is a variety of queries that require scanning on attributes other than spatial, temporal, and keyword. All such scanning efforts are piggybacked on the second phase of the query processor.

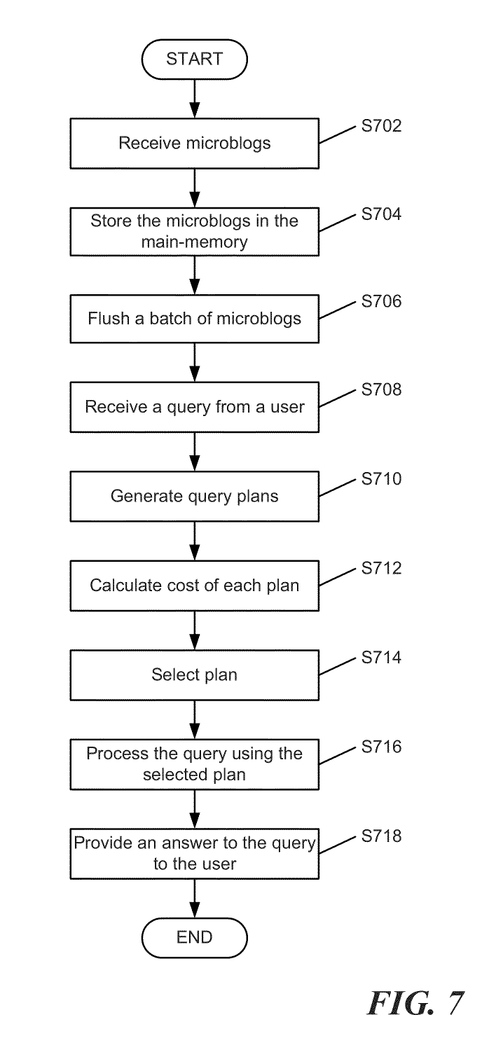

FIG. 7 is a flow chart that shows the operation of the system according to one example. At step S702, the server 100 may receive microblogs from users. The server 100 may also receive microblogs from a plurality of sources. For example, the microblogs may be collected from social networking websites such as Facebook, MySpace, Linkedin, Yahoo Pulse or the like. At step S704, the microblogs are stored in the main-memory as explained above. The main-memory may be temporally partitioned. At step S706, the CPU 1000 may check whether the main-memory is full. In response to determining whether the main-memory is full, the CPU may flush a batch of the microblogs stored in the main-memory to the intermediate disk buffer as explained above. At step S708, the server 100 may receive a query from the user 104. At step S710, the CPU 1000 may determine the possible query plans. At step S712, the CPU 1000 determines the cost of each query plan. At step S714, the CPU 1000 compares the cost of each of the query plans and determines the plan with the lowest cost. At step S716, the CPU 1000 processes the query using the selected plan. At step 718, the answer to the query is provided to the user using the visualizer 200.

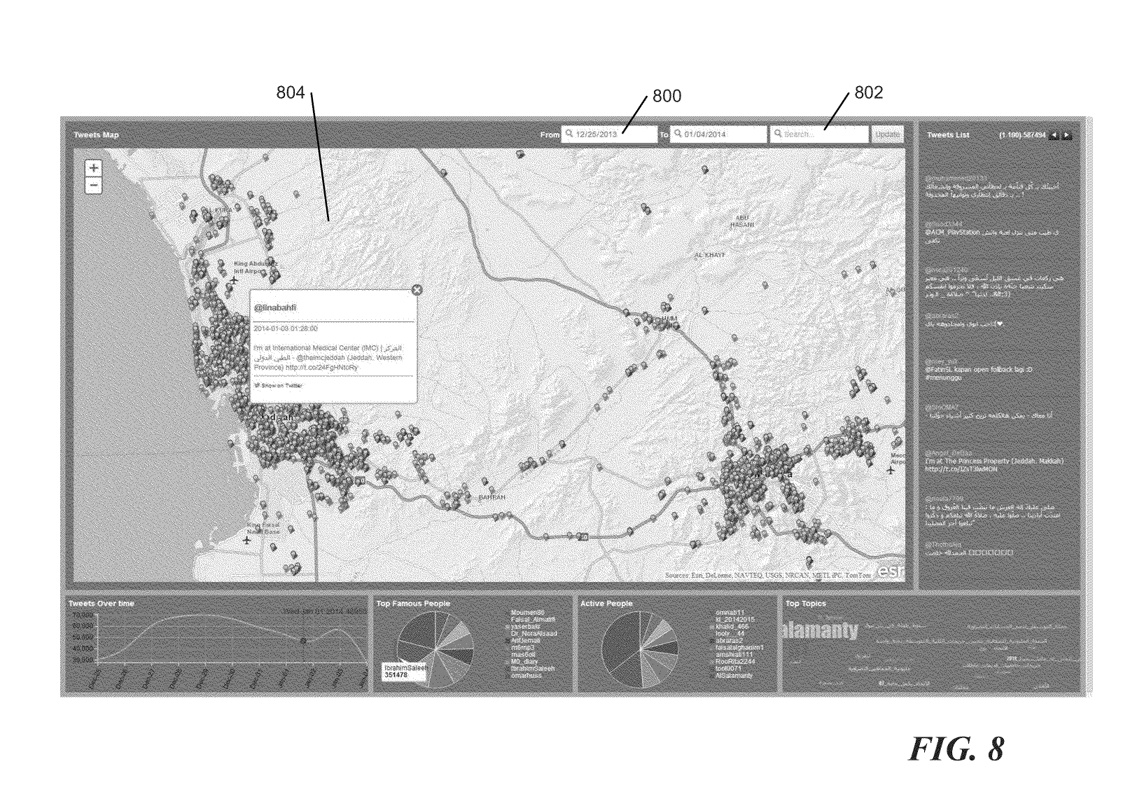

FIG. 8 is an exemplary user interface provided by the system according to one example. FIG. 8 shows the main integrated interface. Through this interface, the user can input a spatial range through a map interface 804, a temporal range through a date picker 800, and optional keywords through text box 802. The system may then dispatches the first six queries as discussed above. The system may use a preset default value for k. For example, k may be taken to equal to 10. The CPU 1000 calculates and presents the results. The results are shown in boxes on the main integrated interface.

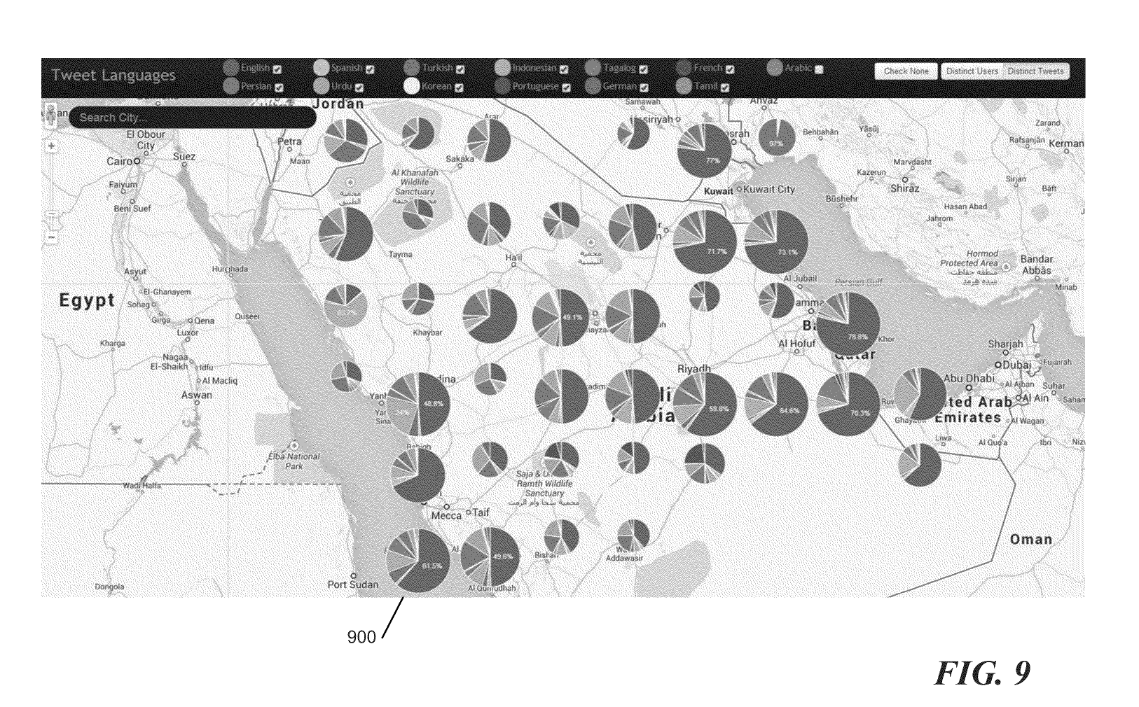

FIG. 9 is an exemplary user interface provided by the system according to one example. The interface 900 may be employed for the seventh query. The seventh query provides an analysis for language usage in Arab Gulf area using Twitter data. The query is issued for all the sub-regions, then the output pie charts are displayed on the map interface. The granularity of the results changes at different zoom levels.

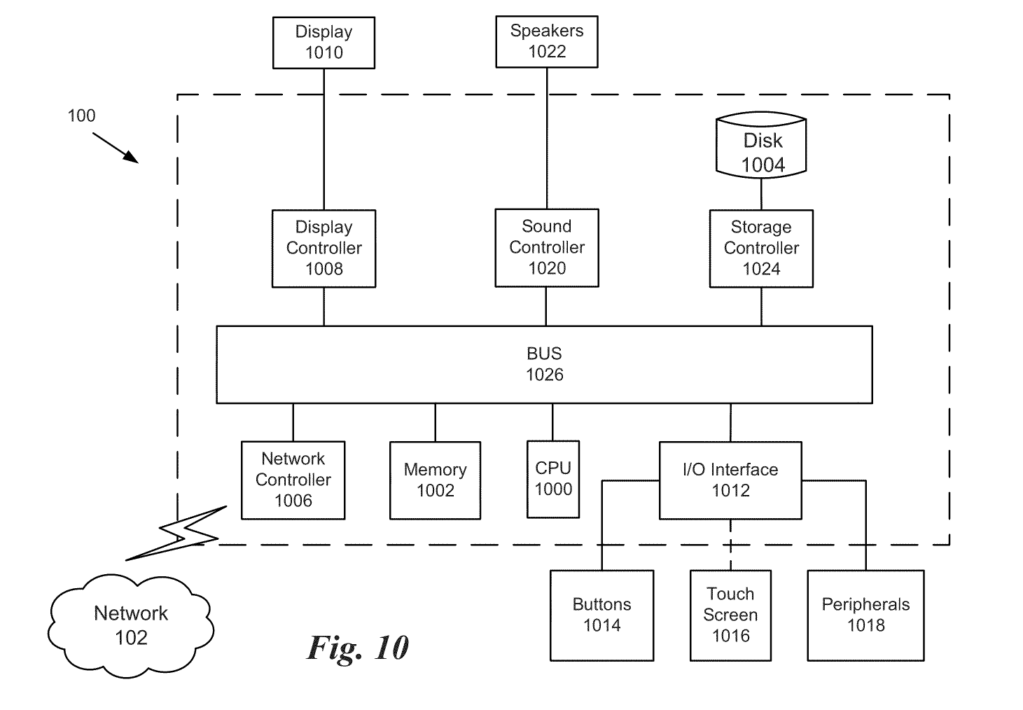

Next, a hardware description of the server 100 according to exemplary embodiments is described with reference to FIG. 10. In FIG. 10, the server 100 includes a CPU 1000 which performs the processes described above/below. The process data and instructions may be stored in memory 1002. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 100 communicates, such as a server or computer.

Further, the claimed advancements may be provided as a utility application, background daemon, or component of an operating system, or combination thereof, executing in conjunction with CPU 1000 and an operating system such as Microsoft Windows 7, UNIX, Solaris, LINUX, Apple MAC-OS and other systems known to those skilled in the art.

The hardware elements in order to achieve the server 100 may be realized by various circuitry elements, known to those skilled in the art. For example, CPU 1000 may be a Xenon or Core processor from Intel of America or an Opteron processor from AMD of America, or may be other processor types that would be recognized by one of ordinary skill in the art. Alternatively, the CPU 1000 may be implemented on an FPGA, ASIC, PLD or using discrete logic circuits, as one of ordinary skill in the art would recognize. Further, CPU 1000 may be implemented as multiple processors cooperatively working in parallel to perform the instructions of the inventive processes described above.

The server 100 in FIG. 10 also includes a network controller 1006, such as an Intel Ethernet PRO network interface card from Intel Corporation of America, for interfacing with network 102. As can be appreciated, the network 102 can be a public network, such as the Internet, or a private network such as an LAN or WAN network, or any combination thereof and can also include PSTN or ISDN sub-networks. The network 102 can also be wired, such as an Ethernet network, or can be wireless such as a cellular network including EDGE, 3G and 4G wireless cellular systems. The wireless network can also be WiFi, Bluetooth, or any other wireless form of communication that is known.

The server 100 further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard.

A sound controller 1020 is also provided in the server 100, such as Sound Blaster X-Fi Titanium from Creative, to interface with speakers/microphone 1022 thereby providing sounds and/or music.

The general purpose storage controller 1024 connects the storage medium disk 1004 with communication bus 1026, which may be an ISA, EISA, VESA, PCI, or similar, for interconnecting all of the components of the server 100. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

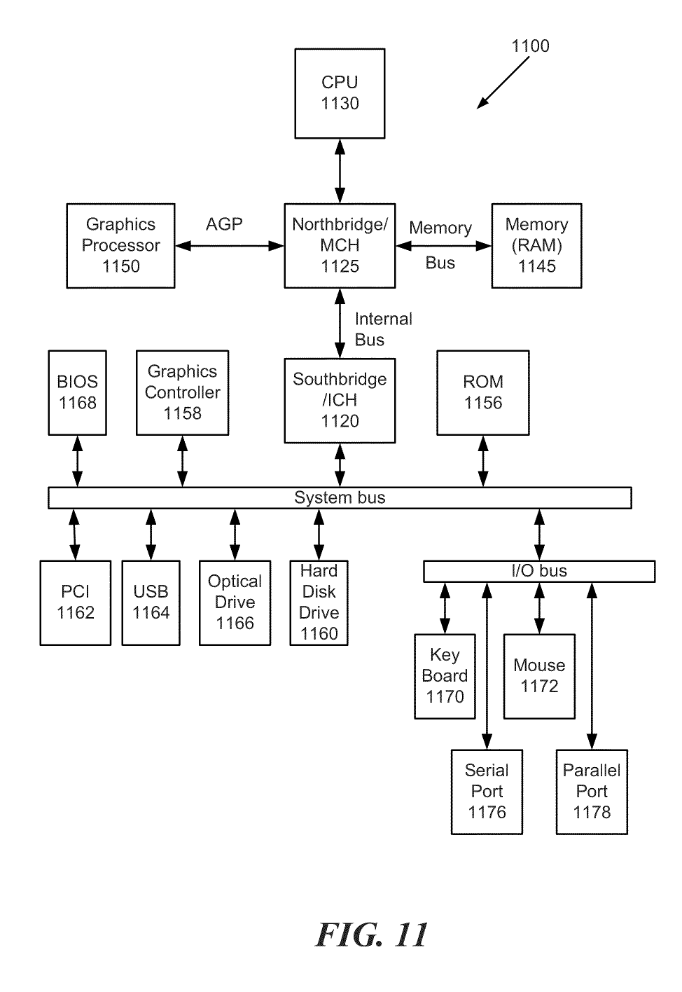

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 11.

FIG. 11 shows a schematic diagram of a data processing system, according to certain embodiments, for microblogs data management. The data processing system is an example of a computer in which specific code or instructions implementing the processes of the illustrative embodiments may be located to create a particular machine for implementing the above-noted process.

In FIG. 11, data processing system 1100 employs a hub architecture including a north bridge and memory controller hub (NB/MCH) 1125 and a south bridge and input/output (I/O) controller hub (SB/ICH) 1120. The central processing unit (CPU) 1130 is connected to NB/MCH 1125. The NB/MCH 1125 also connects to the memory 1145 via a memory bus, and connects to the graphics processor 1150 via an accelerated graphics port (AGP). The NB/MCH 1125 also connects to the SB/ICH 1120 via an internal bus (e.g., a unified media interface or a direct media interface). The CPU Processing unit 1130 may contain one or more processors and even may be implemented using one or more heterogeneous processor systems.

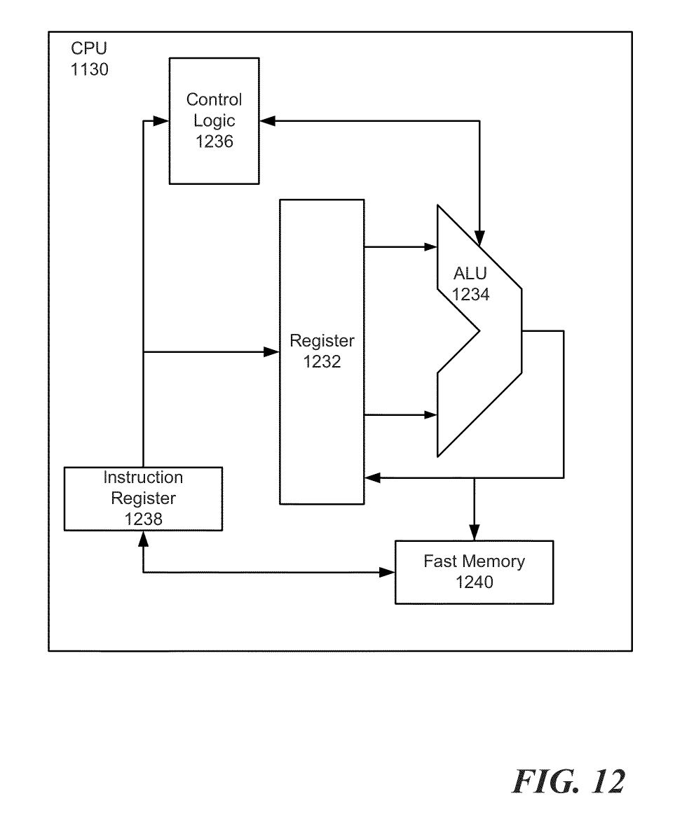

For example, FIG. 12 shows one implementation of CPU 1130. In one implementation, the instruction register 1238 retrieves instructions from the fast memory 1240. At least part of these instructions are fetched from the instruction register 1238 by the control logic 1236 and interpreted according to the instruction set architecture of the CPU 1130. Part of the instructions can also be directed to the register 1232. In one implementation, the instructions are decoded according to a hardwired method, and in another implementation, the instructions are decoded according a microprogram that translates instructions into sets of CPU configuration signals that are applied sequentially over multiple clock pulses. After fetching and decoding the instructions, the instructions are executed using the arithmetic logic unit (ALU) 1234 that loads values from the register 1232 and performs logical and mathematical operations on the loaded values according to the instructions. The results from these operations can be feedback into the register and/or stored in the fast memory 1240. According to certain implementations, the instruction set architecture of the CPU 1130 can use a reduced instruction set architecture, a complex instruction set architecture, a vector processor architecture, a very large instruction word architecture. Furthermore, the CPU 1130 can be based on the Von Neuman model or the Harvard model. The CPU 1130 can be a digital signal processor, an FPGA, an ASIC, a PLA, a PLD, or a CPLD. Further, the CPU 1130 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 11, the data processing system 1100 can include that the SB/ICH 1120 is coupled through a system bus to an I/O Bus, a read only memory (ROM) 1156, universal serial bus (USB) port 1164, a flash binary input/output system (BIOS) 1168, and a graphics controller 1158. PCI/PCIe devices can also be coupled to SB/ICH 1120 through a PCI bus 1162.

The PCI devices may include, for example, Ethernet adapters, add-in cards, and PC cards for notebook computers. The Hard disk drive 1160 and CD-ROM 1166 can use, for example, an integrated drive electronics (IDE) or serial advanced technology attachment (SATA) interface. In one implementation, the I/O bus can include a super I/O (SIO) device.

Further, the hard disk drive (HDD) 1160 and optical drive 1166 can also be coupled to the SB/ICH 1120 through a system bus. In one implementation, a keyboard 1170, a mouse 1172, a parallel port 1178, and a serial port 1176 can be connected to the system bust through the I/O bus. Other peripherals and devices that can be connected to the SB/ICH 1120 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein may also be executed by various distributed components of a system. For example, one or more processors may execute these system functions, wherein the processors are distributed across multiple components communicating in the network 102. The distributed components may include one or more client and server machines, which may share processing, in addition to various human interface and communication devices (e.g., display monitors, smart phones, tablets, personal digital assistants (PDAs)). The network 102 may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

The hardware description above, exemplified by any one of the structure examples shown in FIG. 10, 11, or 12, constitutes or includes specialized corresponding structure that is programmed or configured to perform the algorithm shown in FIGS. 5, 6, and 7.

A system which includes the features in the foregoing description provides numerous advantages to users. In particular, the system of the present disclosure is able to manage and query Billions of microblogs through four main components. The present disclosure improves the functioning of the server by increasing the processing speed by minimizing the need to access disk indexes.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method for microblogs data management, the method comprising:
receiving, via communication circuitry, microblogs from a plurality of sources;
storing, in a memory, the microblogs wherein the memory is temporally partitioned;
transferring, using processing circuitry, a batch of the microblogs to an intermediate disk buffer when the memory is full, wherein the batch of the microblogs is selected based on a query and a temporal flushing policy; and
transferring, using the processing circuitry, microblogs stored in the intermediate disk buffer to disk indexes.

2. The method of claim 1, further comprising:
receiving, via the communication circuitry, a query from a user using a visualization interface;
determining, using the processing circuitry, query plans to process the query based on past queries data, a query keyword count and a query area;
determining, using the processing circuitry, a cost associated with each of the query plans;
selecting, using the processing circuitry, a query plan with the lowest cost;
processing, using the processing circuitry, the query using the selected query plan to determine an answer to the query; and
providing, via the communication circuitry, the answer to the query using the visualization interface.

3. The method of claim 2 wherein the query plans include a keyword query plan and a spatial query plan.

4. The method of claim 3, wherein determining the cost of the keyword query plan include
Cost(keyword|_{q})=A_{kw}×query_keyword_count
where A_{kw} is the average number of microblogs in a key slot.

5. The method of claim 3, wherein determining the cost of the spatial query plan include
Cost(spatial|_{q})=Aₛₚ×query_area
where Aₛₚ is the average number of processed microblogs per query area of one mile square.

6. The method of claim 1, wherein the memory index employs a keyword index and a spatial index.

7. The method of claim 1, wherein the disk index uses at least one of daily segments, weekly segments and monthly segments.

8. The method of claim 1, wherein storing the microblogs include storing replicate data on three or more temporal levels.

9. A system for microblogs data management comprising:
a memory; and
processing circuitry configured to
receive, via communication circuitry, microblogs from a plurality of sources,
store, in the memory, the microblogs wherein the memory is temporally partitioned,
transfer a batch of the microblogs to an intermediate disk buffer when the memory is full, wherein the batch of the microblogs is selected based on a query and a temporal flushing policy, and
transfer microblogs stored in the intermediate disk buffer to disk indexes.

10. The system of claim 9, wherein the processing circuitry is further configured to
receive, via the communication circuitry, a query from a user using a visualization interface;
determine query plans to process the query based on past queries data, a query keyword count and a query area;
determine a cost associated with each of the query plans;
select a query plan with the lowest cost;
process the query using the selected query plan to determine an answer to the query; and
provide, via the communication circuitry, the answer to the query using the visualization interface.

11. The system of claim 10, wherein the query plans include a keyword query plan and a spatial query plan.

12. The system of claim 11, wherein determining the cost of the keyword query plan include
Cost(keyword|_{q})=A_{kw}×query_keyword_count
where A_{kw} is the average number of microblogs in a key slot.

13. The system of claim 11, wherein determining the cost of the spatial query plan include
Cost(spatial|_{q})=Aₛₚ×query_area
where Aₛₚ is the average number of processed microblogs per query area of one mile square.

14. The system of claim 9, wherein the memory index employs a keyword index and a spatial index.

15. The system of claim 9, wherein the disk index uses at least one of daily segments, weekly segments and monthly segments.

16. The system of claim 9, wherein storing the microblogs include storing replicate data on three or more temporal levels.
